(19) United States
(12) Patent Application Publication
(10) Pub. No.: US 2014/0380359 A1
(43) Pub. Date: Dec. 25, 2014

(54) Multi-Person Recommendations in a Media Recommender

(71) Applicant: Luma, LLC, Minneapolis, MN (US)

(72) Inventors: James Musil, Minneapolis, MN (US); Aaron Weber, Orono, MN (US); Colin Keeley, Minneapolis, MN (US); Robert Bodor, Plymouth, MN (US)

(73) Assignee: Luma, LLC, Minneapolis, MN (US)

(21) Appl. No.: 14/483,452

(22) Filed: Sep. 11, 2014

Related U.S. Application Data
(63) Continuation-in-part of application No. 13/792,279, filed on Mar. 11, 2013.
(60) Provisional application No. 61/876,653, filed on Sep. 11, 2013.

(51) Int. Cl. H04N 21/466; H04N 21/475; H04N 21/25; H04N 21/454; H04N 21/258

(52) U.S. Cl. CPC H04N 21/4668; H04N 21/454; H04N 21/25891; H04N 21/4661; H04N 21/4667; H04N 21/252; H04N 21/4756
USPC 725/34

(57) ABSTRACT

A method of providing multi-person media item recommendations comprises receiving media preference information for a plurality of users, and generating a composite media recommendation score for a plurality of media items for a specified group of at least two of the plurality of users using the media preference information for the two or more users for the plurality of media items. A media recommendation is provided for the specified group of at least two of the plurality of users based on the generated composite media recommendation scores for the plurality of media items for the specified at least two of the plurality of users.

### PRIORITY CLAIM AND CROSS-REFERENCE TO RELATED APPLICATIONS

This application claims priority to provisional application 61/876,653, filed Sep. 11, 2013, titled “Media Recommendation”. The present application is further a continuation-in-part of co-pending U.S. patent application Ser. No. 13/792,279 (Attorney Docket 102.002U502), filed on Mar. 11, 2013, which is a continuation-in-part of U.S. patent application Ser. No. 12/892,274 (Attorney Docket 102.002US01), filed on Sep. 28, 2010, now issued as U.S. Pat. No. 8,401,983, and which is further a continuation-in-part of U.S. patent application Ser. No. 12/892,320 (Attorney Docket 102.003US1), filed on Sep. 28, 2010, and which is further continuation-in-part of U.S. patent application Ser. No. 12/903,830 (Attorney docket 102.001US01), filed on Oct. 13, 2010, which in turn claims the priority of U.S. provisional application No. 61/251,191 (Attorney docket 102.001PRV), filed on Oct. 13, 2009. All of the U.S. priority applications are hereby incorporated by reference.

### FIELD

The invention relates generally to media item recommendation, and more specifically to multi-person recommendations in a media recommender.

### BACKGROUND

The rapid growth of the Internet and the proliferation of inexpensive digital media devices have led to significant changes in the way media is bought and sold. Online vendors provide music, movies, and other media for sale on websites such as Amazon, for rent on websites such as Netflix, and available for person-to-person sale on websites such as EBay. The media is often distributed in a variety of formats, such as a movie available for purchase or rental on a DVD or Blu-Ray disc, for purchase and download, or for streaming delivery to a computer, media appliance, or mobile device.

Internet companies that provide media such as music, books, and movies derive profit from their sales, and it is in their best interest to sell customers multiple items or subscriptions to provide an ongoing stream of profits. Netflix, for example, provides a subscription service to customers enabling them to rent or stream movies, and profits as long as subscribers continue to find enough new movies to watch to remain a subscriber. Pandora provides streaming audio in a customized music station format based on a customer's music preferences, deriving profit from either subscriptions or from advertising placed in limited free services. Amazon derives the majority of its profits from sale of physical media, and increases its profit from providing a customer with media recommendations similar to items that a customer has already purchased.

Recommendations such as these are typically made by employing a recommendation engine to identify media that is similar to other media in which a customer has shown an interest, such as by purchasing, renting, or rating related media. Pandora, for example, uses an expert's characterization of a song using domain knowledge attributes such as structure, instrumentation, rhythm, and lyrical content to produce domain knowledge data for each song, and provides streaming songs matching identified customer preferences for one or more distinct customized stations based on its domain knowledge-based recommendation engine. Other media providers such as Netflix provide correlation-based recommendations, where user preferences for similar movies over a broad base of users and media are used to find preference correlation between the media and users in the database to recommend media correlated to other media a customer has liked.

Because the number of items purchased or the length of a subscription are related to the value customers receive in continuing to interact with a media provider, it is in the provider's best interest to provide media recommendations that are accurate and well-tailored to its customers, and that are usable in a variety of media use environments. It is therefore desirable to provide the best quality media recommendations possible in a variety of media commerce and user environments.

### SUMMARY

One example embodiment of the invention comprises a method of providing multi-person media item recommendations. The method comprises receiving media preference information for a plurality of users, and generating a composite media recommendation score for a plurality of media items for a specified group of at least two of the plurality of users using the media preference information for the two or more users for the plurality of media items. A media recommendation is provided for the specified group of at least two of the plurality of users based on the generated composite media recommendation scores for the plurality of media items for the specified at least two of the plurality of users.

In a further example, personal media item recommendation scores are generated for a plurality of media items for the each user of the specified group of at least two users using the received media preference information for the at least two users; and the personal media item recommendation scores are used to generate the composite media recommendation score.

In another example, predicted media item recommendation scores are generated for a plurality of media items for a plurality of users. A request is received for composite media item ratings for at least one media item that will appeal to two or more specified users of the plurality of users. Composite media item ratings are generated for the plurality of media items from the predicted media item recommendation scores for the two or more specified users; and a composite media item recommendation is provided based on the generated composite media item ratings

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a media recommendation system comprising a multi-person media object recommender, consistent with an example embodiment of the invention.

FIG. 2 shows combination of user media preference information to create group media recommendations, consistent with an example embodiment of the invention.

FIG. 3 shows an example screen image of a media item group recommendation system, consistent with an example embodiment of the invention.

FIG. 4 is a flowchart illustrating a method of providing a media recommendation for two or more users, consistent with an example embodiment of the invention.

FIG. 5 is a computerized media recommendation system comprising a multi-person media recommender, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope the examples presented here. The following detailed description does not, therefore, limit the scope of what is claimed.

Recommendation of media such as books, movies, or music that a customer is likely to enjoy can improve the sales of online merchants such as Amazon, improve the subscription rate and duration of rental services such as Netflix, and help the utilization rate of advertising-driven services such as Pandora. Although revenue is derived from providing media in different ways in each of these examples, they all benefit from providing good quality recommendations to customers regarding potential media purchases, rentals, or other media use. Similarly, knowledge of a user's preferences and interests can help target advertising that is relevant to a particular user, such as advertising horror movies only to those who have shown an interest in horror films, targeting country music advertising toward those who prefer country to rap or pop music, and presenting book advertising to those who have shown a preference for similar books.

Media recommendations such as these are typically made by employing a recommendation engine to identify media that is similar to other media in which a customer has shown an interest, such as by purchasing, renting, or rating other similar media. Some websites, such as Netflix, ask a user to rank dozens of movies upon enrollment so that the recommendation engine can provide meaningful results. Other websites such as Amazon rely more upon a customer's purchase history and items viewed during shopping. Pandora differs from these approaches in that a user can rate relatively few pieces of media, and is provided a broad range of potentially similar media based on domain knowledge of the selected media items.

Because the number of items purchased or the length of a subscription are related to the value a customer receives in interacting with a media provider, it is in the provider's best interest to provide media recommendations that are accurate and well-suited to its customers. Poor recommendations may result in a user abandoning a service or merchant for another, while good recommendations will likely result in additional sales and profit. It is therefore desirable to accurately identify and track a user's media preferences to provide the best quality media recommendations possible.

Making accurate recommendations becomes more complex when multiple people are present, such as where a family gathers to watch a movie or where a group of people are traveling together in a car. Media is often selected by one person based on their own preferences or recommendations, anticipating that the person selecting the media can accurately predict media that will be enjoyed by all present. This often results in polling people present for their preferences, indications of who is already familiar with various media items, whether certain media is age-appropriate for all present, and other complications that can easily lead to frustration and dissent among those present.

For example, a family gathering to watch a movie may wish to pick a movie that will be liked by the entire family. Popular action movies may be too violent or contain language not appropriate for the kids, while dramas and documentaries simply don't contain content that kids will find entertaining. Children's movies and animated movies may appeal more to kids, but parents will likely have no idea whether a particular movie known and loved by younger kids will hold any significant entertainment value to teens or adults. If one family member picks a movie, other family members may find the movie less entertaining than anticipated and shift their attention elsewhere, defeating the purpose of having a family movie.

Similarly, picking a family movie through group discussion relies upon each member of the group having enough familiarity with a movie to provide useful preference input, and to indicate certain other factors such as whether they have a strong dislike of the movie or have already seen the movie. One member of the group may enthusiastically lobby for a certain movie, while other members of the group do not lobby for movies that would be better enjoyed by all with equal energy. Such group dynamics can significantly influence the extent to which a chosen movie is enjoyed by the entire group. Similar problems apply when choosing other products or services, such as choosing music to play while taking a family car trip, picking a restaurant to stop at for lunch during the trip, or choosing other reviewed products or services that will be enjoyed by all.

Some embodiments of the invention therefore provide for multi-person recommendations that take user preference information for more than one user into account while making a product or service recommendation. For example, a movie recommendation for a family may use media preference profiles for two parents, a teen, and a child when recommending a movie. The movie recommendation in some embodiments is made using equal weighting or user-selectable weighting for the preferences of the group members, and in a further example takes into account preferences for MPAA rating, target age, and movie content such as sex or violence, including considering such factors based on the youngest or most restrictive member of the group.

The recommendations can take various forms, from naming a single media item from among a group of candidate media items to presenting an ordered list of ranked media items. Ordered rankings include in various embodiments presenting a list of media items ranked by average recommendation score (e.g. 4.9 on a 5.0 scale) for users in the group, or listing media items ranked by average ranking (e.g. first, second, third highest recommended item) for users in the group. The multi-person recommendations may also exclude media items such as movies that group members have seen, such as excluding any movie that any group member or selected group members have previously rated or otherwise indicated that they have seen.

Providing multi-person recommendations such as these results in recommending products or services most likely to satisfy the entire group, avoiding movies, restaurants, or other reviewed items that some group members will strongly dislike. It may seek to maximize enjoyment of the group, or seek to provide recommendations the whole group will enjoy with preference given to certain group members, enhancing overall enjoyment of an item recommended to the group using multi-person recommendation.

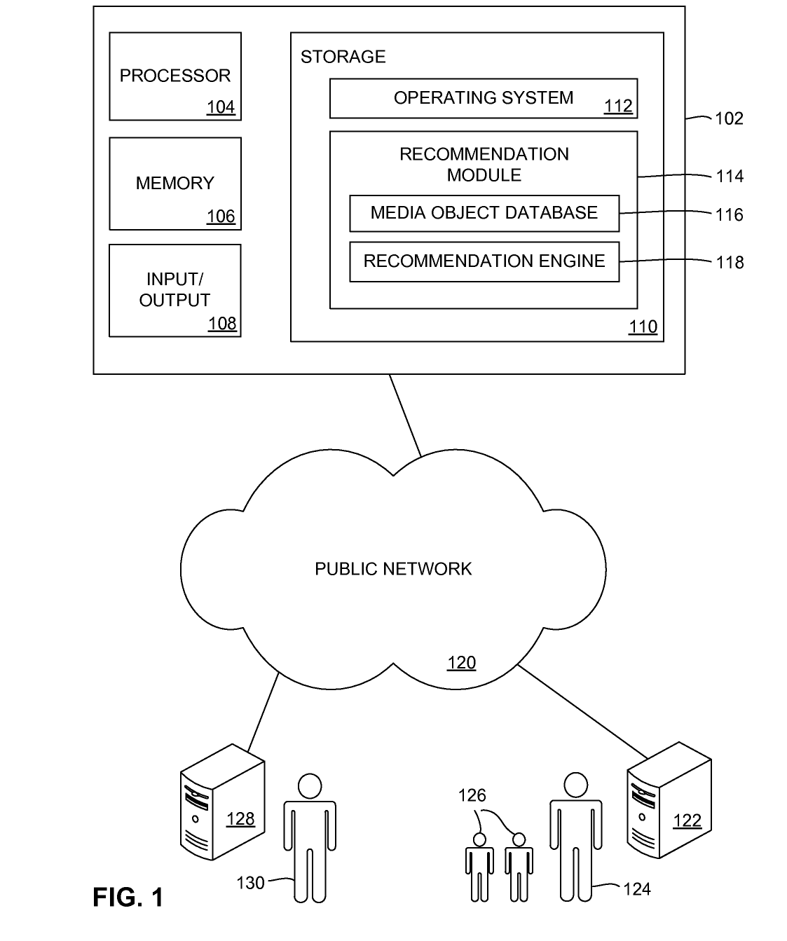

FIG. 1 shows an example media recommendation system operable to provide multi-person recommendations, consistent with an example embodiment of the invention. Here, a media recommendation system 102 comprises a processor 104, memory 106, input/output elements 108, and storage 110. Storage 110 includes an operating system 112, and a recommendation module 114 that is operable to provide media item recommendations to a user, including multi-person media recommendations. The recommendation module 114 further comprises a media object database 116 operable to store media object information and user preference information for various media objects, and a recommendation engine 118 operable to use the stored media preference information for users to provide media recommendations.

The media recommendation system 102 is connected to a public network 120, such as the Internet. Public network 120 serves to connect the media recommendation system media recommendation system 102 to remote computer systems, including user's computer 122 (associated with user 124 and kids 126), and user computer 128 (associated with user 130).

In operation, the media recommendation system's processor 104 executes program instructions loaded from storage 110 into memory 106, such as operating system 112 and recommendation module 114. The recommendation module includes software executable to provide media recommendations to users such as user 124 or to groups of users, using recommendation engine 118 and media object database 116.

The media item recommendations generated by recommendation engine 118 are based in some examples upon media preference information for a user, such as information regarding a user's media purchases, ratings, and viewings, across multiple websites and services. To produce the most accurate media recommendations, media recommendation system 102 gathers such media preference information to populate a media object database 116 containing each user's preferences. This information can then be used to generate recommendations for other media items, such as by using correlation-based recommendations, domain knowledge-based recommendations, or recommendations made using a combination of correlation-based and domain knowledge-based information.

In some examples, the media recommendations provided are provided to individual users, based on each user's previously provided media preferences such as ratings, purchases, or rentals. In other examples, the media recommendation engine provides recommendations for two or more users, such as a user logged in to the recommendation service and one or more users associated with the logged in user, such as friends, family, or social media contacts.

For example, user 124 may be logged in to the media recommendation system 10w through public network 120 using computer 122. User 124 wishes to obtain a media recommendation for a movie to watch, but wishes to find a movie that he will enjoy watching with kids 126. Because media preference profiles for each of the two kids 126 are available, and the user profiles for kids 126 are associated with user 124's account, the user 124 can request recommendations for a movie that user 124 and both kids 126 will enjoy. The media recommendation module 114 uses media object database media 116 preference records for each of these three people to generate a recommendation for one or more movies that all will enjoy, and provides the recommendation to user 124 via computer 122 and public network 120.

In another example, user 124 wishes to watch a movie with another user 130, who has created his own media preference profile via computer 128 and public network 120 coupled to the media recommendation system 102. User 124 has in some examples added user 13 as a friend, invited user 130 to watch a movie, or otherwise indicated a desire to associate his user account on media recommendation system 102 with user 130's media recommendation system account. In a further example, user 130 consents to the association before user 124 can search for media that both will enjoy, thereby protecting user 130's media preference information from unwanted disclosure. In another example, user 124 may not search for movies that only user 130 will like, but can only search for movies that he will himself like, either alone or on conjunction with other users.

Multi-person media recommendations are generated in recommendation engine 118 by any suitable method that considers the media preferences of indicated users in various embodiments. In one example, the recommendation rank for each user in the multi-person group (e.g. first, second, or third recommended movie) is averaged for each media item ranked for all members of the group, and presented to the user as a ranked list. In another example, the user rating (e.g. 4 out of 5, 5 out of 5) for each user in the multi-person group is averaged for each media item, and the media items having a predicted ranking for all members of the group are listed in order of the average rating. Still other methods will use sums, averages, or other calculations of other metrics, such as the sum or average score generated by a recommendation engine in generating each user's media preference predictions.

The recommendations provided to the user comprise an ordered list in these examples, but in other examples may be sorted into groups (e.g. all will love, all will like, all will find OK), may be presented as single recommendations, or may be presented in another manner. The presentation of the recommended movie in further examples is accompanied by the recommended media item's group rank, group rating, sorted group, or other indication of the item's predicted appeal to the group, enabling the user to take such factors in to consideration when choosing a media item.

The media items recommended for a group of users in some embodiments have at least a threshold personal media item recommendation score or rating for each member of the group, ensuring that no member of the group will hate the recommended media item. For example, if all members of a family except one generally like vampire movies, a new vampire movie may be rated relatively high on a group recommendation list for the family as a group. If the one member of the family that does not like vampire movies strongly dislikes vampire movies, their personal recommendation score for the new vampire movie may be quite low, reflecting that they will strongly dislike the new vampire movie. Because it may be desirable to avoid movies that at least one member of the group will strongly dislike, the group recommendation engine in some examples will remove the new vampire movie from consideration for recommending to the group based on the recommendation score for the new vampire movie for the user who dislikes vampire movies from meeting a threshold score.

The threshold score in a further example is user-configurable, such that the user seeking a group recommendation can turn the threshold filter on or off in seeking group media recommendations. In another example, the user can configure the threshold score below which a media item will not be considered, such as searching for movies everybody will rate at least 3 out of 5, 4 out of 5, or the like. This enables a user to selectively exclude movies that will not meet a certain minimum threshold for all group members, or to include movies that most members of the group will like but relatively few may dislike, such as where a large group is watching a movie or where at least one member of the group has particularly difficult or different media tastes relative to the rest of the group.

Media preference information for each user may in a further example be normalized before combining predicted media item scores to generate a group recommendation score. For example, a first user in the group may rate nearly all movies four out of five or five out of five, with only one movie in twenty earning a score as low as three out of five. A second user in the same group may have a relatively equal distribution of ones, twos, threes, fours, and fives, meaning that the first user's rating of three means that the first user is likely to dislike the movie, while the second user's rating of three indicates the user is likely to find the movie to be about average. Scaling scores for all users in the group, such as scaling them to approximately the same distribution as the scores of the user requesting the group recommendation, will result in greater equality in influence of each group member's predicted score for each recommended media item, and provide more meaningful results to the user requesting the group recommendation.

In this example, the second user is requesting the recommendation, and the first user's scores are normalized to have the same relatively equal distribution as the second user's scores. For example, the first user's predicted media ratings rated three out of five may be converted to a one, items rated 3.5 converted to a two, items rated four converted to a three, items rated 4.5 converted to a four, and items rated five left rated five before the first user's predicted media ratings are used in generating a composite group media item predicted rating.

This helps ensure that the influence or weight of the preferences of each user in the group are equally considered or equally weighted, resulting in recommendations that are not biased toward people who rate movies more harshly than others. In some embodiments, the weighting or relative influence of preferences of various users in the group can be configured or specified, such as by receiving weightings or other input from a user as part of a group media recommendation request. For example, two parents wishing to find a movie to watch with a single child may wish to weight the child's preferences 60% and each of them 20%, ensuring that the movie selected will appeal mainly to the child but also be tolerable to each parent. In other examples, a user may wish to increase the weighting of a guest invited over for a movie, decrease the weighting of a particularly picky or quirky member of a group, or otherwise change relative weighting of preferences of various group members to get different results.

Some media items may be rate highly for a group, but not appropriate for all members of a group. For example, a movie rated “R” may have the highest rating for a family with two adults, an older teen, and a grade school child, but may contain violence, sex, language, drug use, and other elements not appropriate for the grade school child. Some examples of media recommendation system 102 therefore provide a mechanism to restrict recommendation results to results that are appropriate for all members of the group, such as by using age information associated with each user to select only movies appropriate for the age of all members of the group. In a more detailed example, the user requesting the group media recommendation is provided a mechanism to specify what media is acceptable, based on factors such as MPAA rating (G, PG, PG-13, etc.) by TV parental guidelines (TV-Y, TV-PG, TV-MA, etc.), or by other media ratings. In an alternate embodiment, content such as sex, violence, drug use, language, and other such age-based content can be individually specified and filtered, resulting in greater control over what movies or other media are recommended for a group.

Some media such as movies may be rated as appropriate for children using MPAA or other similar ratings, but may not be targeted to kids or of interest to kids. For example, a documentary on economic issues leading to the great depression may contain no foul language, sex, violence, or other objectionable material, and may therefore receive a “G” rating, despite being of absolutely no interest to children younger than at least middle teens. Such media items in some embodiments are therefore associated with a recommended or target age range, separate from MPAA or similar rating, indicating an intended age range for each rated media item. A user seeking a media item such as a movie for a group can then specify a desired age range, or search based on the age ranges of the members of the group for media items having an intended age range covering all members of the group.

Media items included in multi-person recommendations for a group include in some examples only media items such as movies that have not been seen by any user in the group, thereby ensuring that no member of the group will find a recommended movie boring due to having previously seen the movie. In a further example, the user requesting the group recommendation can set whether to exclude previously viewed movies for each user in the group, or users can set whether they wish to exclude media items they have previously seen when they participate in various groups for recommendations.

In a more complex example, user configuration may distinguish between media item types or sources, such as excluding in-theater movies a user has previously seen but including rental or streaming movies previously seen by the same user.

Determination of whether a user has previously used a media item such as a having previously seen a movie includes in one example evaluation of whether the user's data records in media object database 116 include a rating for the media item, a record of purchase or rental for the media item, or another indication of the user's interaction with the media item. In a more detailed example, movies in a user's queue are explicitly determined not to have been seen, even if previously rated, while other movies that have been rated or purchased are explicitly considered to have been previously seen and may be excluded from group recommendation.

Members in some embodiments must consent to be a member of a group, thereby protecting the confidentiality of the users' preference information. For example, a user may wish to invite other users into a “circle” or invite them as friends using media recommendation system 102, thereby granting access to their media preference information for use as a member of a group. Users have an incentive to share their preference information in this way to ensure that their preferences are considered in making a group decision. In a more detailed example, a user may not directly query a friend's preferences, but can only query their preferences in seeking recommendations for a group having at least two users to provide some protection of the friend's preference confidentiality.

In further examples, a user can join groups or circles, propose getting together for a movie all would enjoy, or take other actions to establish groups, circles, or friend relationships with other users, enabling the user to use the friends' media preferences in seeking media recommendations. The friend in some examples must consent to be added to another user's friends, groups, or circles, enabling the friends to protect the confidentiality of their preference information from users with whom they do not wish to associate.

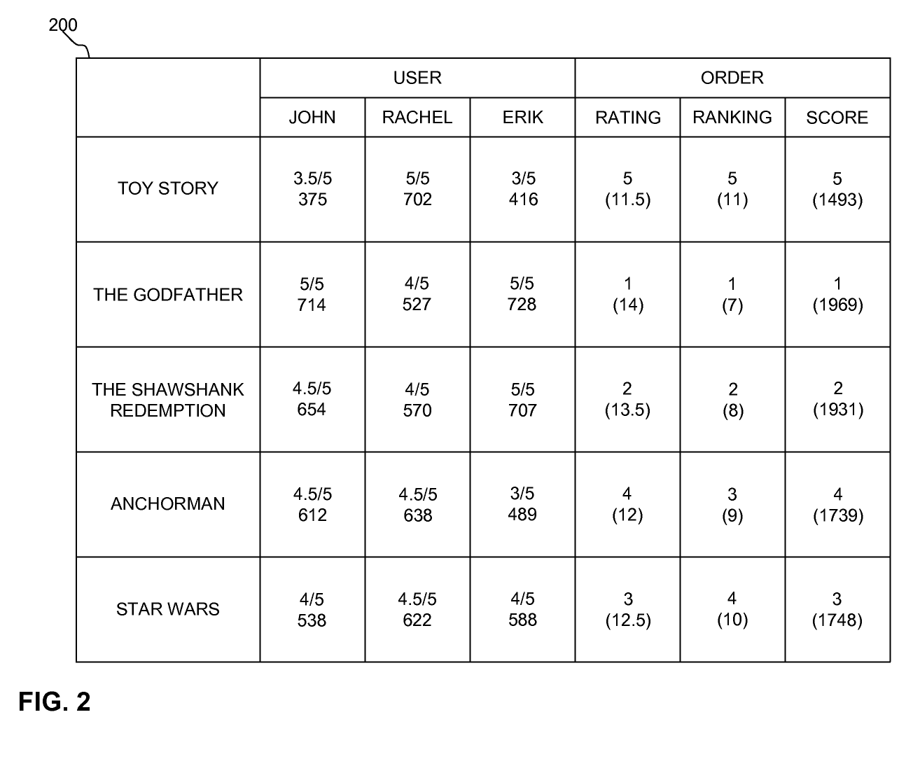

FIG. 2 shows combination of user media preference information to create group media recommendations, consistent with an example embodiment of the invention. Here, five different movies as shown generally at 200 have not been seen by any of three different users in a group, John, Rachel, and Erik. The media recommendation module 114 of FIG. 1 has calculated a predicted rating (e.g. 4 out of 5) for each movie for each user in the group, based at least in part on a score (e.g. 375) that is derived for each user for each movie in this example from each user's preferences for other media and similarity between various media items.

Here, a higher score corresponds to a higher projected rating, such that Rachel's 702 score for “Toy Story” corresponds to a projected rating of 5/5 while John's 375 score for “Toy Story” corresponds to a projected rating of 3.5/5. Further, each movie has a rank, or order of preference for each user, based on preference information such as the score or projected rating for each item. For example, John's first-ranked movie is “The Godfather”, while “The Shawshank Redemption” is ranked second and “Anchorman” is ranked third, based on score for each movie.

Information such as the rating, ranking, or score for each user in the group for each media item is used to generate a group rating for each media item, so that media items can be recommended to the group based on the preferences of the group's members. Three examples of determining a recommendation order for the five movies shown are illustrated in the three columns under “Order”, including rating, ranking, and score-based ordering of the movies.

Referring first to the “Rating” column, the rating (e.g., 3.5/5) for each member of the group is here simply added together for each movie, such as adding 3.5, 5, and 3 for “Toy Story” to generate a group rating of 11.5. The five movies in the data set are then ordered based on their group ratings, such that higher-rated movies like “The Godfather” with a group rating of 13.5 are ordered or listed before movies having a lower rating, such as “Toy Story” with a rating of 11.5. In other examples, the scores are averaged, summed, multiplied, or combined using other suitable algorithms to generate a group rating for each media item.

In another example, media items are ordered based on ranking, such as being ranked first, second, or third in order of predicted preference for each user. Referring again to FIG. 2 at 200, the movie “Toy Story” is ranked 5^{th} among John's movies, 1^{st} among Rachel's movies, and 5^{th} among Erik's movies, for a summed ranking score of 11, placing this movie lowest among group rankings for the five media items shown. In contrast, “The Godfather” has a predicted ranking of 1st for both John and Erik, and 5^{th} for Rachel, resulting in a group ranking score of seven, placing “The Godfather” in first position among the five media items ordered based on group ranking.

Other metrics are used in other examples, such as raw prediction score as shown in the “Score” column of FIG. 2. Here, the scores for each user are added for each media item, such as adding John's 375, Rachel's 702, and Erik's 416 to generate a group score of 1493 for “Toy Story”. The five movies in this example are then ordered based on their group score, such that “The Godfather” is listed first with its group score of 1969, while “Toy Story” is ordered last with a score of 1493.

These examples illustrate how predicted user preferences for media items can be combined to create predicted group scores for media items, enabling recommendation of a media item such as a movie that will be enjoyed by the group. Although the example of FIG. 2 shows only five movies, which may be typical of recommending which movie of a relatively small number of movies to see at a Cineplex, other examples such as selecting a movie from Netflix may include thousands of movies in the group recommendation calculation.

The movies in the example of FIG. 2 are presented to the users as an ordered list of movies, but in other examples the media item recommendations provided for the group may be provided in other ways, such as in groups or as single media items. Providing media item recommendations by item group in a more detailed example comprises grouping or classifying the recommended media items into groups for presentation, such as “Will like”, “Will Love”, and “Will think is Okay”. In another example, a single media item is recommended at a time, and a user either accepts the media item or asks for another suggestion for the group. Such single item presentation in further examples is presented as a page flow, as a separate sequential page for each media item, or otherwise presented with enhance focus on one media item relative to other recommended media items.

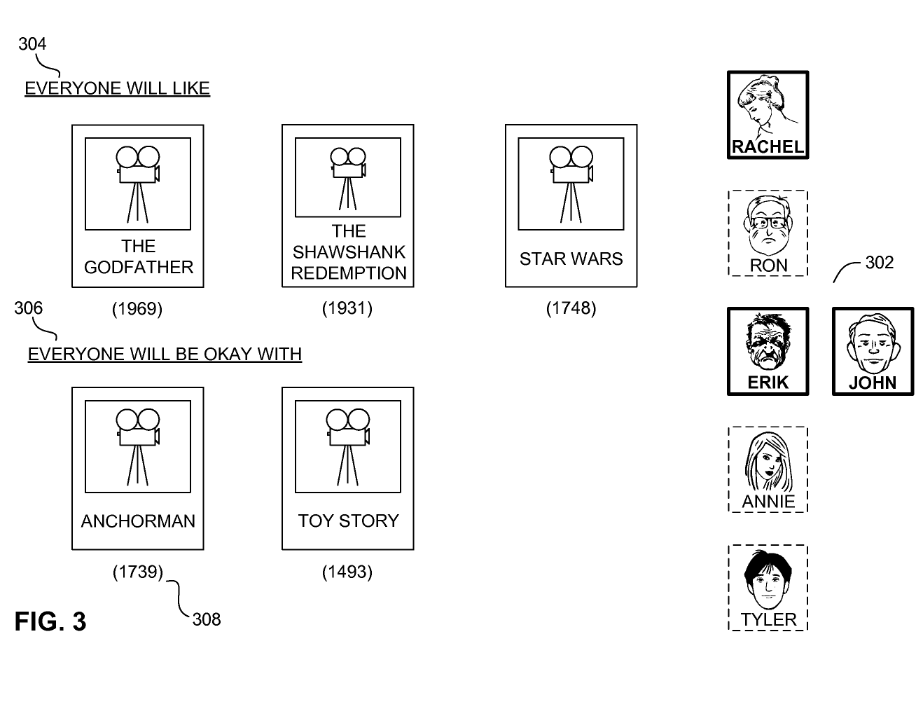

FIG. 3 shows an example screen image of a media item group recommendation system, consistent with an example embodiment of the invention. Here, user “John” is logged in to a media recommendation system such as 102 of FIG. 1 using a computer, a tablet computer, a smart phone, or another such device. The logged in user “John” has selected “Rachel” and “Erik” to watch a movie with from among his group of friends, creating a group of three people. The screen image also shows additional people in John's friends or circle that are not part of the current group, including Ron, Annie, and Tyler.

The three members of the group and the five movies in the media set correspond to the users and media items in the example of FIG. 2, including the same three people and a media data set including the same five movies. In FIG. 3, the media recommendation system 102 has provided media recommendations for the group consisting of John, Rachel, and Erik based on categorization of movies, showing at 304 that “Everyone Will Like” three of the movies, including “The Godfather”, “The Shawshank Redemption”, and “Star Wars”. The screen image also reflects at 306 that among the group, “Everyone Will Be Okay With” the movies “Anchorman” and “Toy Story”.

The movies in this example are further ordered in each category in order of predicted preference, such that the media recommendation system 102 has predicted that the group will like “The Godfather” better than “The Shawshank Redemption” or “Star Wars”. In other examples, the movies are not broken down into categories, but are simply presented in an ordered list or other presentation.

In a further example, a numerical or other indication of predicted preference is shown for some or all movies presented, such as showing that movies “Everyone Will Like” are predicted as being ranked 4 out of 5 or higher, while movies that “Everyone Will Be Okay With” are rated at least 3 out of 5. In another example, a score, ranking, rating, or other calculated predicted group rating for each movie is presented, as is shown at 308.

In this example, each movie is presented with the “score” calculated in the example of FIG. 3, enabling a user to see more information regarding the recommendation for each movie. For example, the user can observe that the media recommendation engine has predicted that “The Godfather” and “The Shawshank Redemption” will both be liked relatively strongly with little difference between the two movies, while “Star Wars” will be liked somewhat less, and is closer in score to “Anchorman” than to the other two movies in the “Everyone Will Like” category.

This example shows a simple filtering of a data set of five movies based on media preferences for a group of three people, but other examples will include larger or differently structured groups, such as adding a family or circle to a group, and larger or different groups of media, such as thousands of streaming movies available, movies available from different sources such as rental, streaming, and theaters, and different media types or other goods and services such as songs or albums, restaurants, and other preference-based items.

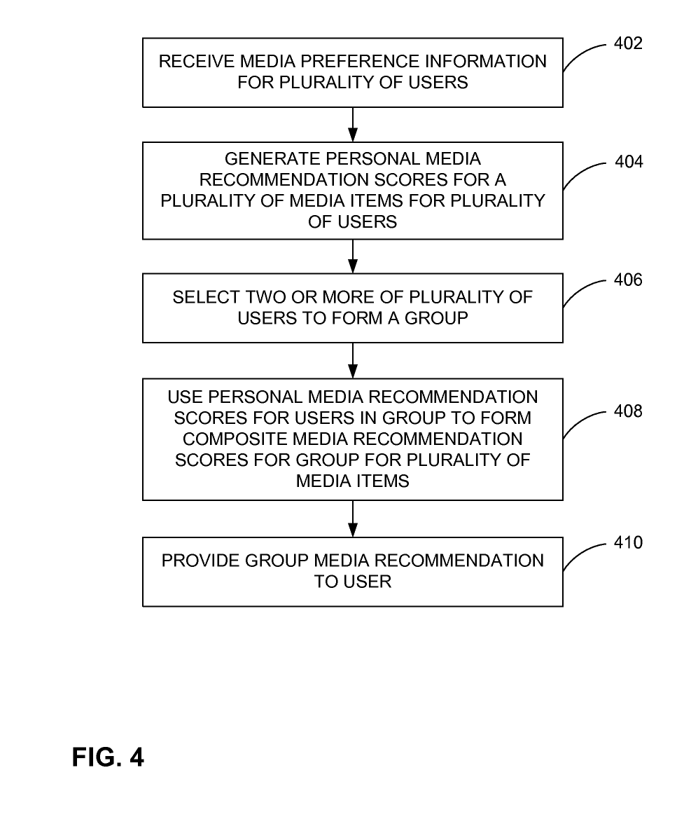

FIG. 4 is a flowchart illustrating a method of providing a media recommendation for two or more users, consistent with an example embodiment of the invention. At 402, a recommendation system such as 102 of FIG. 1 receives media preference information for two or more users, such as receiving ratings on previously watched media, records of past purchases, or the like. The recommendation system generates personal media recommendation scores for a plurality of media items for a plurality of users at 404, such as by using an algorithm to derive predicted media preference scores for media that each user has not yet seen.

A user selects two or more of the plurality of users at 406, to form a group of users. The group is made up of users with whom the selecting user wishes to view media such as a movie, and for whom the selecting user wishes to receive a group media recommendation. The group media recommendation comprises a recommendation for one or more media items that the group of users will like, including in other embodiments recommendations for non-media items such as restaurants or other goods or services that are reviewable or for which preference can be estimated.

The recommendation system 102 uses the personal media recommendation scores generated at 404 for the users in the group formed at 406 to generate a composite media recommendation score for each of the plurality of media items at 408, such that the composite media recommendation score reflects how well the media recommendation system predicts the group will like the various media items. The composite media recommendation scores for the group are then used to provide a group media recommendation to the requesting user at 410, such as recommending a media item that the media recommendation system predicts will like best, or presenting a ranked or categorized list of media items for the users. In a further example, the group media recommendation is provided to other members of the group, such as by an email, a recommendation system message, a recommendation system web page, or other suitable mechanism.

A multi-person recommendation system such as this is able to provide a user with more useful information than simply providing a separate list of recommendations for each user, enabling the user requesting a group recommendation to make a better decision or a group than might otherwise be possible. Group media recommendations in a further example also use knowledge of the group members, such as age or other characteristic, to suggest movies appropriate for all group members.

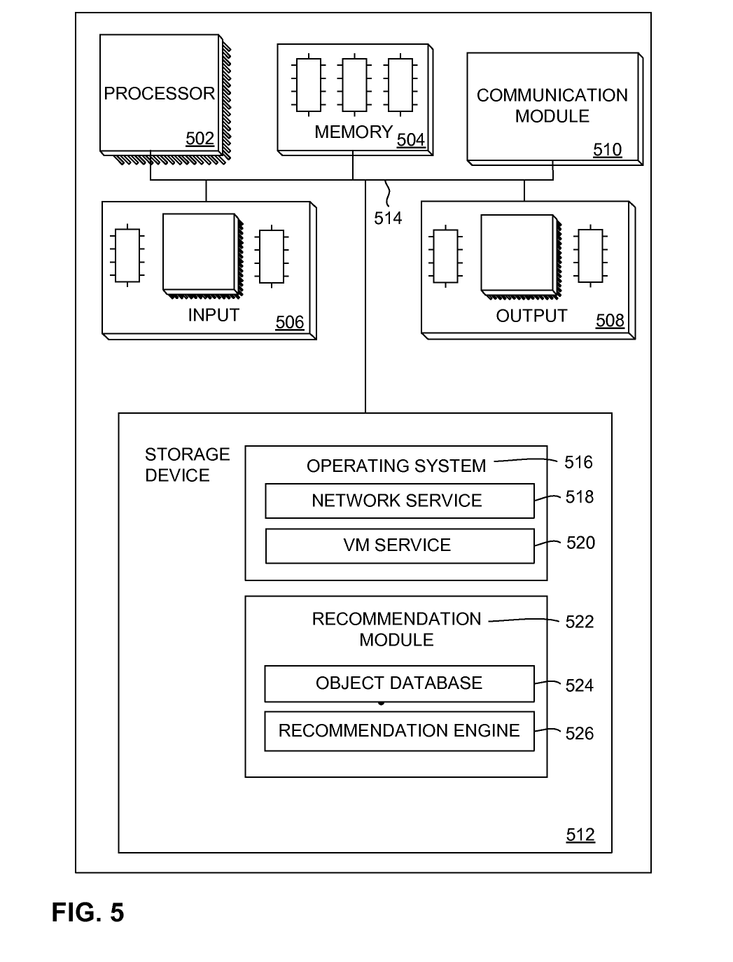

FIG. 5 is a computerized media recommendation system comprising an object mapping module, consistent with an example embodiment of the invention. FIG. 5 illustrates only one particular example of computing device 500, and other computing devices 500 may be used in other embodiments. Although computing device 500 is shown as a standalone computing device, computing devices 500 may be any component or system that includes one or more processors or another suitable computing environment for executing software instructions in other examples, and need not include one or more of the elements shown here.

As shown in the specific example of FIG. 5, computing device 500 includes one or more processors 502, memory 504, one or more input devices 506, one or more output devices 508, one or more communication modules 510, and one or more storage devices 512. Computing device 500, in one example, further includes an operating system 516 executable by computing device 500. The operating system includes in various examples services such as a network service 518 and a virtual machine service 520 such as a virtual server. One or more applications, such as recommendation module 522 are also stored on storage device 512, and are executable by computing device 500. Each of components 502, 504, 506, 508, 510, and 512 may be interconnected (physically, communicatively, and/or operatively) for inter-component communications, such as via one or more communications channels 514. In some examples, communication channels 514 include a system bus, network connection, interprocessor communication network, or any other channel for communicating data. Applications such as recommendation module 522 and operating system 516 may also communicate information with one another as well as with other components in computing device 500.

Processors 502, in one example, are configured to implement functionality and/or process instructions for execution within computing device 500. For example, processors 502 may be capable of processing instructions stored in storage device 512 or memory 504. Examples of processors 502 include any one or more of a microprocessor, a controller, a digital signal processor (DSP), an application specific integrated circuit (ASIC), a field-programmable gate array (FPGA), or similar discrete or integrated logic circuitry.

One or more storage devices 512 may be configured to store information within computing device 500 during operation. Storage device 512, in some examples, is described as a computer-readable storage medium. In some examples, storage device 512 comprises temporary memory, meaning that a primary purpose of storage device 512 is not long-term storage. Storage device 512 in some examples is a volatile memory, meaning that storage device 512 does not maintain stored contents when computing device 500 is turned off. In other examples, data is loaded from storage device 512 into memory 504 during operation. Examples of volatile memories include random access memories (RAM), dynamic random access memories (DRAM), static random access memories (SRAM), and other forms of volatile memories known in the art. In some examples, storage device 512 is used to store program instructions for execution by processors 502. Storage device 512 and memory 504, in various examples, are used by software or applications running on computing device 500 such as recommendation module 522 to temporarily store information during program execution.

Storage device 512, in some examples, includes one or more computer-readable storage media that may be configured to store larger amounts of information than volatile memory. Storage device 512 may further be configured for long-term storage of information. In some examples, storage devices 512 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 500, in some examples, also includes one or more communication modules 510. Computing device 500 in one example uses communication module 510 to communicate with external devices via one or more networks, such as one or more wireless networks. Communication module 510 may be a network interface card, such as an Ethernet card, an optical transceiver, a radio frequency transceiver, or any other type of device that can send and/or receive information. Other examples of such network interfaces include Bluetooth, 3G or 4G, WiFi radios, and Near-Field Communication s (NFC), and Universal Serial Bus (USB). In some examples, computing device 500 uses communication module 510 to wirelessly communicate with an external device such as via public network 120 of FIG. 1.

Computing device 500 also includes in one example one or more input devices 506. Input device 506, in some examples, is configured to receive input from a user through tactile, audio, or video input. Examples of input device 506 include a touchscreen display, a mouse, a keyboard, a voice responsive system, video camera, microphone or any other type of device for detecting input from a user.

One or more output devices 508 may also be included in computing device 500. Output device 508, in some examples, is configured to provide output to a user using tactile, audio, or video stimuli. Output device 508, in one example, includes a display, a sound card, a video graphics adapter card, or any other type of device for converting a signal into an appropriate form understandable to humans or machines. Additional examples of output device 508 include a speaker, a light-emitting diode (LED) display, a liquid crystal display (LCD), or any other type of device that can generate output to a user.

Computing device 500 may include operating system 516. Operating system 516, in some examples, controls the operation of components of computing device 500, and provides an interface from various applications such as recommendation module 522 to components of computing device 500. For example, operating system 516, in one example, facilitates the communication of various applications such as recommendation module 522 with processors 502, communication unit 510, storage device 512, input device 506, and output device 508. Applications such as recommendation module 522 may include program instructions and/or data that are executable by computing device 500. As one example, recommendation module 522 and its object database 524, and recommendation engine 526 may include instructions that cause computing device 500 to perform one or more of the operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of providing a media recommendation for two or more users, comprising:
receiving media preference information for a plurality of users;
generating a composite media recommendation score for a plurality of media items for a specified group of at least two of the plurality of users using the media preference information for the two or more users for the plurality of media items; and
providing a media recommendation for the specified group of at least two of the plurality of users based on the generated composite media recommendation scores for the plurality of media items for the specified at least two of the plurality of users;
wherein at least one of the receiving media preference information, generating media item recommendation scores, generating a composite media recommendation score, and providing a media recommendation are performed via a processor in a computerized system.

2. The method of providing a media recommendation for two or more users of claim 1, further comprising:
generating personal media item recommendation scores for a plurality of media items for the each user of the specified group of at least two users using the received media preference information for the at least two users; and
using the personal media item recommendation scores to generate the composite media recommendation scores.

3. The method of providing a media recommendation for two or more users of claim 2, wherein providing a media recommendation for the specified group of at least two of the plurality of users further comprises providing recommendations for media items that have at least a threshold personal media item recommendation score for each user of the specified group.

4. The method of providing a media recommendation for two or more users of claim 1, wherein generating a composite media recommendation score comprises using an average recommendation score for the plurality of media items for the at least two users of the specified group to calculate the composite media recommendation score for each of the plurality of media items.

5. The method of providing a media recommendation for two or more users of claim 1, wherein generating a composite media recommendation score comprises using an average ranking for the plurality of media items for the at least two users of the specified group to calculate the composite media recommendation score for each of the plurality of media items.

6. The method of providing a media recommendation for two or more users of claim 1, wherein generating a composite media recommendation score comprises normalizing media preference information for the specified at least two of the plurality of users before using the media preference information to generate a composite media recommendation score.

7. The method of providing a media recommendation for two or more users of claim 1, wherein generating a composite media recommendation score comprises equally weighting media preference information for each user in the specified group of users in generating a composite media recommendation.

8. The method of providing a media recommendation for two or more users of claim 1, wherein providing a media recommendation for the specified group of at least two of the plurality of users comprises filtering media items by target age range based on the ages of the at least two of the plurality of users.

9. The method of providing a media recommendation for two or more users of claim 1, wherein providing a media recommendation for the specified group of at least two of the plurality of users comprises filtering media items by age rating based on the ages of the at least two of the plurality of users.

10. The method of providing a media recommendation for two or more users of claim 1, wherein providing a media recommendation for the specified group of at least two of the plurality of users comprises filtering media items by at least one of sex, language, violence, and adult themes.

11. The method of providing a media recommendation for two or more users of claim 1, wherein providing a media recommendation for the specified group of at least two of the plurality of users comprises providing a media recommendation for media items that have not been rated by any users in the specified group.

12. The method of providing a media recommendation for two or more users of claim 1, wherein generating a composite media preference score comprises generating the composite media preference score based at least in part on user-selectable weighting for at least one of the specified two or more users in the group.

13. A computerized system, comprising:
a processor operable to execute software instructions;
a multi-person recommendation module, operable when executed on the processor to:
receive media preference information for a plurality of users;
generate a composite media recommendation score for a plurality of media items for a specified group of at least two of the plurality of users using the media preference information for the two or more users for the plurality of media items; and
provide a media recommendation for the specified group of at least two of the plurality of users based on the generated composite media recommendation scores for the plurality of media items for the specified group of at least two of the plurality of users.

14. The computerized system of claim 13, the multi-person media recommendation module further operable when executed on the processor to:
generate personal media item recommendation scores for a plurality of media items for the each user of the specified group of at least two users using the received media preference information for the at least two users; and
use the personal media item recommendation scores to generate the composite media recommendation score.

15. The computerized system of claim 14, wherein providing a media recommendation for the specified group of at least two of the plurality of users further comprises providing recommendations for media items that have at least a threshold personal media item recommendation score for each user of the specified group.

16. The computerized system of claim 13, wherein providing a media recommendation for the specified group of at least two of the plurality of users comprises providing recommendations for media items derived from age-appropriate content of the media items and the ages of the users in the specified group.

17. The computerized system of claim 13, wherein providing a media recommendation for the specified group of at least two of the plurality of users comprises providing a media recommendation for media items that have not been rated by any users in the specified group.

18. A method of providing a media item recommendation for two or more users, comprising:
generating predicted media item recommendation scores for a plurality of media items for a plurality of users;
receiving a request for composite media item ratings for at least one media item that will appeal to two or more specified users of the plurality of users;
generating composite media item ratings for the plurality of media items from the predicted media item recommendation scores for the two or more specified users; and
providing a composite media item recommendation based on the generated composite media item ratings;
wherein at least one of the generating predicted media item ratings, receiving a request for composite media item ratings, generating composite media item ratings, and providing a composite media item recommendation are performed via a processor in a computerized system.

19. The method of claim 18, wherein providing a composite media item recommendation comprises providing a composite media item recommendation for one or more media items not yet rated by any of the two or more specified users.

20. The method of claim 18, wherein providing a composite media item recommendation further comprises providing composite media item recommendations for a plurality of media items ranked by the composite media item rating for each of the plurality of media items.
